(19) United States
(12) Patent Application Publication
(10) Pub. No.: US 2020/0070240 A1
(43) Pub. Date: Mar. 5, 2020

(54) LIGHT WEIGHT INSERTS FOR PISTON RINGS, METHODS OF MANUFACTURING THEREOF AND ARTICLES COMPRISING THE SAME

(71) Applicant: GM GLOBAL TECHNOLOGY OPERATIONS LLC, Detroit, MI (US)

(72) Inventors: Jeremy R. Kirklin, Novi, MI (US); Richard D. Ricchi, Lapeer, MI (US)

(21) Appl. No.: 16/120,740

(22) Filed: Sep. 4, 2018

(51) Int. Cl. B21K 1/76; C22C 21/02; B22F 5/02; B21J 5/02; F16J 9/26

(52) U.S. Cl. CPC B21K 1/761; C22C 21/02; B22F 2301/052; B21J 5/025; F16J 9/26; B22F 5/02

(57) ABSTRACT

A method for manufacturing an insert for an aluminum piston comprises applying pressure to a composition that comprises aluminum. The composition is deformed to form the insert for aluminum piston. The insert comprises an aluminum alloy and the insert functions as a ring carrier. Disclosed herein too is an article that comprises an insert for a piston. The article is manufactured from a composition that comprises aluminum. The insert is manufactured by a process that comprises applying pressure to the composition to form the insert.

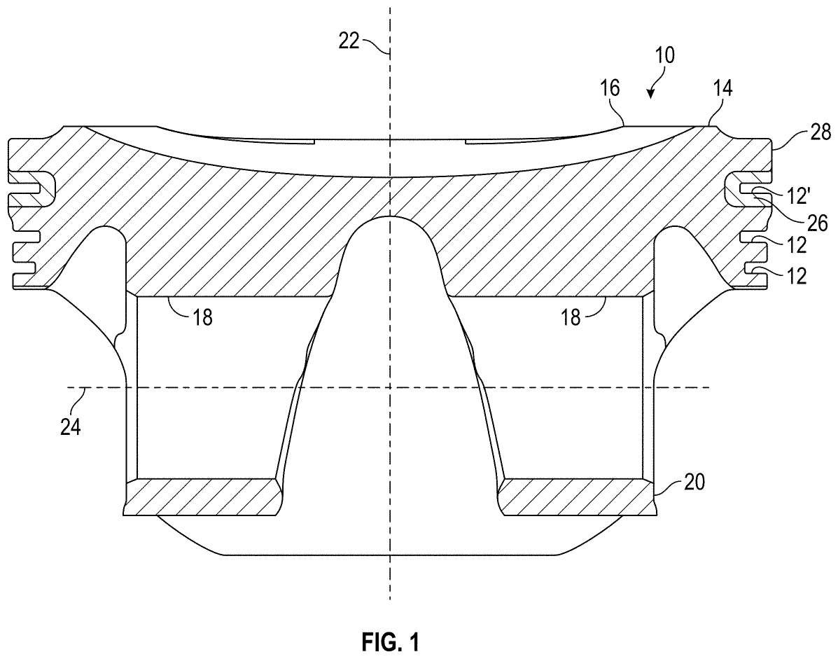

### INTRODUCTION

The subject disclosure relates to light weight inserts for piston rings, methods of manufacturing thereof and to articles comprising the same.

A piston for use in an internal combustion engine includes an insert (also referred to sometimes as a ring insert or ring carrier) about its circumferential extent. Grooves are formed in an outer radial face of the insert and are adapted to receive piston rings. Ring inserts are used to protect the piston/ring against unpredictable over-pressure events, known as SPI (stochastic pre-ignition). Stochastic pre-ignition (SPI), is a pre-ignition event that occurs in gasoline vehicle engines when there is a premature ignition of the main fuel charge.

Currently commercially available ring inserts are generally formed from a nickel-rich ferrous alloy having a greater hardness and resistance to wear than the material of the piston body and piston crown. The use of nickel-rich, ferrous alloys have solved a couple of problems, namely (1) ring groove “pound out”—mechanical deformation and wear of the ring groove due to contact with the piston ring is reduced; and (2) resistance to unpredictable high pressure combustion events (SPI). Customer piston warranty evidence has shown that pistons with ring inserts have more resistance to ring land breakage during these SPI events. Warranty evidence is evidence obtained from returned goods that are under warranty.

Warranty evidence also suggests that forged aluminum pistons have similar resistance to SPI events, even though they do not have a Ni-rich ferrous ring carrier. It is believed that this resistance to SPI is due to work hardening of the material which results in a finely aligned aluminum microstructure, which offers inherently more toughness than a cast structure.

Nickel-rich ferrous alloy ring inserts have a number of drawbacks, one of which is their increased weight. Nickel-rich ferrous alloy ring inserts have specific gravities of greater than 7.0 g/cc as compared with approximately 2.74 g/cc for aluminum ring inserts. High density ring carrier materials increase the weight of the piston and overall reciprocating mass of the engine crank train.

One alternative to a ferrous metal insert is an insert formed of an alloy having increased hardness and wear resistance with a thermal expansion similar to that of the piston head and piston body. However, such alloys must be customized for a particular application, and are both difficult and expensive to develop. Further, the use of such an alloy does not eliminate a problem known as microwelding, wherein material from a piston ring and the insert are exchanged thereby bonding the ring to the insert. Such unwanted bonding may result in piston failure. Nor do such alloys provide any type of dry lubrication between a piston ring and an insert.

Another alternative to a ferrous metal insert involves the use of methods wherein material is applied in a customized fashion to a non-cast piston body and head and then machined to form an insert. The customized application of material to a non-cast piston is expensive, and subject to unreliability.

Accordingly, it is desirable to provide inserts that offer robustness against SPI events (like iron ring inserts), but that overcome the various disadvantages listed above. It is desirable to offer ring inserts that more closely resemble the aluminum piston body material in respect to its specific gravity, coefficient of thermal expansion and heat conductivity but that have toughness and strength similar to a forged aluminum piston.

### SUMMARY

A method for manufacturing an insert for an aluminum piston comprises applying pressure to a composition comprising aluminum. The composition is then deformed to form the insert for aluminum piston. The insert comprises an aluminum alloy and functions as a ring carrier.

Disclosed herein too is an article comprising an insert for a piston comprising a composition that comprises aluminum. The insert is manufactured by a process that comprises applying pressure to form the insert.

The composition for manufacturing the insert comprises 2 to 20 wt % of silicon, 2 to 6 wt % of copper, 1 to 5 wt % of iron, and 0.1 to 4 wt % of one or more of the following elements: magnesium, manganese, vanadium, scandium, nickel, titanium, strontium, zinc, or boron, with the remainder being aluminum, where the weight percents are based on a total weight of the composition.

In an alternative embodiment, the composition for manufacturing the insert comprises 5 to 14 wt % of silicon, 3 to 5 wt % of copper, 2 to 4 wt % of iron, and 0.1 to 4 wt % of one or more of the following elements: magnesium, manganese, vanadium, scandium, nickel, titanium, strontium zinc, or boron, with the remainder being aluminum, where the weight percents are based on a total weight of the composition.

In yet another embodiment, the composition for manufacturing the insert comprises 5 to 14 wt % of silicon, 3 to 5 wt % of copper, 2 to 4 wt % of iron, and 0.1 to 4 wt % of two or more of the following elements: magnesium, manganese, vanadium, scandium, nickel, titanium, strontium zinc, or boron, with the remainder being aluminum, where the weight percents are based on a total weight of the composition.

The applying of pressure to form the insert is accomplished via forging, stamping, rolling, extrusion, or a combination thereof.

In an embodiment, the forging comprises cold forging, the rolling comprises cold rolling and the extrusion comprises cold extrusion, where the cold forging, cold rolling and cold extrusion are conducted at or near room temperature.

In yet another embodiment, the forging comprises hot forging, the rolling comprises hot rolling and the extrusion comprises hot extrusion, where the hot forging, hot rolling and hot extrusion are conducted at temperatures of greater than 200° C.

The insert may be manufactured by sintering the composition. The sintering the composition is conducted prior to applying pressure. The sintering is conducted at a temperature of between 300 to 650° C. for 5 minutes to 3 hours preferably 590 to 620° C. for 20 to 30 minutes to form a sintered compact that can then be handled and subjected to any method of deformation that results in work hardening of the material.

The sintering of the composition is conducted prior to applying the pressure; where the sintering is conducted at a temperature of 250° C. or greater for 5 to 20 hours to form a sintered compact.

The cold forging is conducted at a pressure of 200 to 400 MPa, the cold extrusion is conducted at a pressure of 200 to 400 MPa and the cold rolling is conducted at a pressure of 200 to 400 MPa. Pressures are dependent on the flow stress of the material at the processing temperature. The flow temperature is process independent.

The hot forging is conducted at a pressure of 10 to 90 MPa and a temperature of 300 to 600° C., the hot extrusion is conducted at a pressure of 20 to 110 kg/cm² and a temperature of 230 to 480° C. and the hot rolling is conducted at a pressure of 30 to 140 MPa and a temperature of 200 to 400° C.

In an exemplary embodiment, an article comprises an insert for a piston comprising a composition that comprises aluminum; where the insert is manufactured by a process that comprises applying pressure to form the insert.

In yet another exemplary embodiment, the process comprises applying pressure comprises forging, stamping, rolling, extrusion, or a combination thereof.

In yet another embodiment, the forging comprises cold forging, the rolling comprises cold rolling and the extrusion comprises cold extrusion, where the cold forging, cold rolling and cold extrusion are conducted at or near room temperature.

In yet another embodiment, the forging comprises hot forging, the rolling comprises hot rolling and the extrusion comprises hot extrusion, where the hot forging, hot rolling and the hot extrusion are conducted at temperatures greater than 200° C.

The process for manufacturing the insert further comprises sintering the composition prior to applying the pressure. The sintering is conducted at a temperature of 250° C. or greater for 5 to 20 hours to form a green compact.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the FIGURE is a depiction of an exemplary ring insert.

### DETAILED DESCRIPTION

The following description is merely exemplary in nature and is not intended to limit the present disclosure, its application or uses.

In accordance with an exemplary embodiment, disclosed herein is an insert (a ring carrier) for a piston of an internal combustion engine, where the insert that comprises a high-strength, heat treatable, aluminum alloy. The aluminum alloy preferably comprises aluminum as the base metal. Other metals present in the alloy include one or more of the following elements: silicon, iron, copper, magnesium, manganese, vanadium, scandium, titanium, strontium zinc, boron, and chromium.

The insert is manufactured by methods that include the use of pressure such as, for example, those that deform the material during manufacturing, so to achieve a fine, anisotropic microstructure and sub-structure. These methods include forging, extruding, stamping, rolling, cold-rolling, and the like, to achieve the desired microstructure.

With reference now to the FIGURE, in an embodiment a piston 10 comprises three ring grooves 12, 12′ but any desired number of such ring grooves may be provided. The crown surface is indicated at 14, and a combustion bowl 16 is formed in this crown surface. Gudgeon pin bores 18 extend through bosses provided in the piston below the ring grooves 12. A piston skirt is indicated at 20. Also shown in the drawing is the piston axis 22 and the axis 24 of the gudgeon pin bores 18.

An insert 26 comprising the high strength heat-treated aluminum alloy is disposed in a groove located on a circumferential surface 28 (also sometimes referred to the piston land) of the piston near the piston crown 14. The insert 26 has in it a ring groove 12′ that accommodates a piston ring (not shown).

The aluminum alloy is a metallic alloy and may contain 2 to 20 wt % of silicon, 2 to 6 wt % of copper, 1 to 5 wt % of iron, and optionally 0.1 to 4 wt % of one or more of the following elements: magnesium, manganese, vanadium, scandium, nickel, titanium, strontium, zinc, or boron. The remainder of the alloy comprises aluminum. All of the elements detailed above are in metallic form. Oxides, nitrides, carbides, or the like, if present are present in trace amounts as impurities.

In another embodiment, the aluminum alloy comprises 5 to 14 wt % of silicon, 3 to 5 wt % of copper, 2 to 4 wt % of iron, and optionally 0.5 to 3 wt % of one or more of the following elements: magnesium, manganese, vanadium, scandium, nickel, titanium, strontium zinc, and boron. The remainder of the alloy comprises aluminum. In an embodiment, there may be two or more of elements such as magnesium, manganese, vanadium, scandium, nickel, titanium, strontium, zinc, and boron, present in an amount of 0.1 to 4, preferably 1 to 2 wt %, based on the total weight of the aluminum alloy. All weight percents are based on the total weight of the aluminum alloy.

In an exemplary embodiment, the aluminum alloy composition that can be forged into the insert comprises 0.1 to 12.2 wt % of silicon, 0.2 to 4.4 wt % of copper, 0.25 to 2.5 wt % of magnesium, 0.05 to 1 wt % of nickel, 0.12 to 1 wt % of iron, 0.1 to 0.6 wt % of manganese, 0.07 to 0.25 wt % of titanium, 0.1 to 5.60 wt % of zirconium, with the remainder being aluminum.

The insert may be manufactured via a pressurization-based process that can include forging, extruding, stamping, rolling, and the like. Forging is preferred. The pressurization can be conducted cold or hot. Cold pressurization is conducted at or near room temperature. Near room temperature includes temperatures that are within 20 degrees of room temperature. Hot pressurization occurs at temperatures greater than 200° C. Details of each method are provided below.

In an embodiment, the aforementioned metals are generally first compacted in powder form to produce a green compact that can be further processed. The powder is first taken in a mold and compressed to a volume of 65% or greater, preferably 75% or greater, more preferably 85% or greater, and more preferably 95% or greater of the volume of the mold.

The green compact may be sintered in a convection type heating furnace (i.e. non-induction type furnace) at a temperature of 250° C. to 650° C. for about 5 to 20 hours to form the sintered compact. The sintered compact may then be further subjected to a pressurization process such as cold or hot forging, cold or hot extrusion, cold or hot rolling, stamping, or the like.

Forging is a manufacturing process involving the shaping of a metal using localized compressive forces. In an embodiment, the sintered compact may be subjected to forging to produce the insert. The forging can include both cold forging and hot forging.

In producing a preform of such strength that no cracks are formed during forging, it is desirable that the density be increased to a sufficiently high level via cold forging and then an optional second sintering step can be conducted on the initial sintered compact. The density (during the cold or hot forging) can be satisfactorily increased by increasing the compacting pressure. In an embodiment, cold forging is performed via cold-isostatic pressing. This method is more effective than the ordinary pressing using a metal die. This high density cold compacting destroys any oxide coating on the powdered particles, thereby greatly increasing the contact area of the particles. During forging, residual voids present in the initial sintered compact are collapsed. The second sintering step, which is generally performed after the cold forging step, results in the formation of an oxide free compact of high density with very few voids.

Cold forging is performed at a temperature of 0 to 200° C. In a preferred embodiment, the cold forging is performed at a temperature of 20 to 100° C. A second sintering step may be performed on a cold forged part at a temperature of 300° C. to 600° C., preferably 250 to 550° C. for about 5 to about 20 hours. The second sintering step facilitates the formation of a fined-grain microstructure and sub-structure. The cold forging is conducted at a pressure of 200 to 400 MPa.

Hot forging may be employed in place of cold forging or alternatively, in addition to cold forging. One of the reasons for hot forging (in lieu of or in addition to cold forging) is that the sintering proceeds sufficiently and to a greater extent than in cold forging for the same pressures. Another reason is that deformation resistance to the forging is reduced (because of the elevated temperatures during the forging process) and as a result, deformation into complicated shapes can be attained. By hot forging to a true density ratio (where the true density ratio is the density of the particles that make up the powder, in contrast to the bulk density, which measures the average density of a large volume of the powder in a specific medium (usually air)) of at least 95%, voids are minimized and internal oxidation resulting from entrapped air in the voids is reduced.

Hot forging is performed at a temperature of 200 to 600° C. In a preferred embodiment, the hot forging is performed at a temperature of 350 to 550° C. The hot forging is conducted at a pressure of 10 to 90 MPa.

In another embodiment, the insert may be produced by extrusion. In extrusion, the metal alloy is subjected to a pressure effective to deform it and emanates from a die that has the shape of the desired article. Extrusion can include both cold extrusion and hot extrusion. Cold extrusion is done at room temperature or near room temperature. Cold extrusion minimizes oxidation of the insert, and results in a product having a higher strength due to cold working, closer tolerances, better surface finish, and fast extrusion speeds. Cold extrusion is conducted at extrusion ratios of at least 2:1, preferably greater than 3:1, and more preferably greater than 4:1.

The cold extrusion is performed at a pressure of 200 to 400 MPa. In a preferred embodiment, the cold extrusion is performed at a pressure of 220 to 300 MPa.

Hot extrusion generally is performed at elevated temperatures. Because of the use of elevated temperatures, extrusion ratios in hot extrusion are generally greater than those employed in cold extrusion. In hot extrusion, the extrusion ratio is generally greater than 4:1 and preferably greater than 10:1.

Hot extrusion is performed at a temperature of 230 to 480° C. In a preferred embodiment, the hot extrusion is performed at a temperature of 250 to 400° C.

The insert may also be produced by rolling. Rolling can include cold rolling or hot rolling. Like cold extrusion, cold rolling increases the strength of the insert via strain hardening, through compression and alignment of the microstructure. The increase in strength can be up to 20% greater than the strength of the same part produced by hot rolling or hot extrusion. Cold rolling is performed at or near room temperature.

Hot rolling is performed at a temperature of 200 to 400° C. In a preferred embodiment, the hot rolling is performed at a temperature of 220 to 380° C.

The product obtained from the forging, extrusion, rolling, or any other pressurized process may then be placed within the piston mold and cast within the piston during pouring of the molten aluminum Prior to casting, the insert may be optionally machined and/or subjected to surface treatments or otherwise be modified to achieve a good bond with the cast piston material. This may involve removal or modification of the stable, passive oxide layer on the surface through chemical, mechanical, or other methods. Surface treatments may include shot blasting, sand blasting, lapping, grinding, electrolytic deposition of a coating, laser melting, and the like, on the insert.

A piston ring (not shown) may then be disposed in the insert and the assembled piston placed in an engine cylinder. The assembly may then be used in an automobile.

In an embodiment, the specific gravity of the insert is 2.5 grams per cubic centimeter (g/cc) to 3.20 g/cc, preferably 2.6 to 3.0 g/cc, and more preferably 2.7 to 2.9 g/cc. The insert preferably has a coefficient of thermal expansion that facilitates compatibility with the cast aluminum material of the piston. The coefficient of thermal expansion would be in the range of 16×10′ to 26×10′ per degree (Celsius or Kelvin). The use of a matching coefficient of thermal expansion between the insert and the piston prevents separation of the insert from the piston. This prevents blow-by of the hot gases generated in the cylinder and further prevents damage to the piston and cylinder that is caused by the loosening of the insert or by breaking of the insert.

In one embodiment, in one method of disposing the insert on a piston, the (light-weight) insert is alfin-treated (treated with molten aluminum) and an aluminum alloy is cast around the insert so that the insert forms the ring support portion of the piston. A ring groove is then machined along the outer periphery of the ring support portion of the insert. In the alfin treatment, the insert is dipped into molten aluminum alloy and then an aluminum alloy is cast there-around with the aim of improving bonding strength between the aluminum alloy and the insert.

The microstructure of the “formed” insert (i.e. forged, extruded, stamped, rolled, or the like) exhibits a fully dense, anisotropic structure; characterized by alignment of the grains and sub-grains with substantially modified primary silicon particles when compared to the cast structure of the piston.

Other advantages derived from the manufacture of the insert using a pressurized process involving forging, extrusion, rolling, stamping, and the like are that it can potentially replace a completely forged piston, which is both costly and heavier than a cast piston. Forging (or alternatively extruding, rolling or stamping) only the insert (the ring carrier) of the piston is less costly and more mass efficient, while providing the same level of toughness as a completely forged aluminum piston.

The overall piston design would be weight neutral versus an approximately 20 gram increase in piston weight with a nickel-rich ferrous-based insert. The piston design would retain the same functional cast benefits such as weight-optimized shape and structure. These pressurized methods for producing the insert are compatible with high volume production techniques and versatile (they can accommodate multiple cast piston suppliers) unlike forged pistons (which do not easily accommodate multiple piston suppliers). The machining process for forged aluminum inserts (versus nickel-resist inserts) is simpler because they are easier to machine, use less time to optimize feeds/speeds, and use lower production complexity. In developing tools using only one material, no separation of material is necessary in chip reclamation systems; it makes recycling easier.

The insert is preferably used in pistons for internal combustion engines. They are preferably used in engines that use diesel as fuel for the combustion process (i.e., diesel engines). In another embodiment, the insert is used in engines that use gasoline as fuel for the combustion process

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method for manufacturing an insert for an aluminum piston comprising:
applying pressure to a composition comprising aluminum;
deforming the composition to form the insert for the aluminum piston;
wherein the insert comprises an aluminum alloy and wherein the insert functions as a ring carrier.

2. The method of claim 1, where the composition comprises 2 to 20 wt % of silicon, 2 to 6 wt % of copper, 1 to 5 wt % of iron, and 0.1 to 4 wt % of one or more of the following elements: magnesium, manganese, vanadium, scandium, nickel, titanium, strontium, zinc, or boron, with the remainder being aluminum, where the weight percents are based on a total weight of the composition.

3. The method of claim 1, where the composition comprises 5 to 14 wt % of silicon, 3 to 5 wt % of copper, 2 to 4 wt % of iron, and 0.1 to 4 wt % of one or more of the following elements: magnesium, manganese, vanadium, scandium, nickel, titanium, strontium, zinc, or boron, with the remainder being aluminum, where the weight percents are based on a total weight of the composition.

4. The method of claim 1, where the composition comprises 5 to 14 wt % of silicon, 3 to 5 wt % of copper, 2 to 4 wt % of iron, and 0.1 to 3 wt % of two or more of the following elements: magnesium, manganese, vanadium, scandium, nickel, titanium, strontium, zinc, or boron, with the remainder being aluminum, where the weight percents are based on a total weight of the composition.

5. The method of claim 1, wherein the applying pressure is accomplished via forging, stamping, rolling, extrusion, or a combination thereof.

6. The method of claim 5, where the forging comprises cold forging, the rolling comprises cold rolling and the extrusion comprises cold extrusion, where the cold forging, cold rolling and cold extrusion are conducted at or near room temperature.

7. The method of claim 5, where the forging comprises hot forging, the rolling comprises hot rolling and the extrusion comprises hot extrusion, where the hot forging, hot rolling and the hot extrusion are conducted at temperatures greater than 200° C.

8. The method of claim 1, further comprising sintering the composition prior to applying the pressure; where the sintering is conducted at a temperature of 250° C. or greater for 5 to 20 hours to form a sintered compact.

9. The method of claim 1, further comprising fitting the insert into a piston.

10. The method of claim 1, further comprising fitting a ring into the insert.

11. The method of claim 6, where the cold forging is conducted at a pressure of 200 to 400 MPa, the cold extrusion is conducted at a pressure of 200 to 400 MPa and the cold rolling is conducted at a pressure of 200 to 400 MPa.

12. The method of claim 7, where the hot forging is conducted at a pressure of 10 to 90 MPa and a temperature of 300 to 600° C., the hot extrusion is conducted at a pressure of 20 to 110 MPa and a temperature of 230 to 480° C. and the hot rolling is conducted at a pressure of 30 to 140 MPa and a temperature of 200 to 400° C.

13. An article comprising:
an insert for a piston comprising a composition that comprises aluminum;
where the insert is manufactured by a process that comprises applying pressure to form the insert.

14. The article of claim 13, where the process that comprises applying pressure comprises forging, stamping, rolling, extrusion, or a combination thereof.

15. The article of claim 14, where the forging comprises cold forging, the rolling comprises cold rolling and the extrusion comprises cold extrusion, where the cold forging, cold rolling and cold extrusion are conducted at or near room temperature.

16. The article of claim 14, where the forging comprises hot forging, the rolling comprises hot rolling and the extrusion comprises hot extrusion, where the hot forging, hot rolling and the hot extrusion are conducted at temperatures greater than 200° C.

17. The article of claim 13, further comprising sintering the composition prior to applying the pressure; where the sintering is conducted at a temperature of 250° C. or greater for 5 to 20 hours to form a green compact.
